(19) United States
(12) Patent Application Publication
(10) Pub. No.: US 2013/0272795 A1
(43) Pub. Date: Oct. 17, 2013

(54) LANDFILL INCLUDING LAYER OF COMPOSITE PARTICLES

(71) Applicant: AQUABLOK, LTD., Toledo, OH (US)

(72) Inventor: John H. Hull, Toledo, OH (US)

(21) Appl. No.: 13/646,572

(22) Filed: Oct. 5, 2012

Related U.S. Application Data
(60) Provisional application No. 61/543,452, filed on Oct. 5, 2011.

(51) Int. Cl. B09B 1/00

(52) U.S. Cl. CPC B09B 1/004
USPC 405/129.45

(57) ABSTRACT

A landfill includes a layer of solid waste and a barrier layer provided on top of the layer of solid waste. The barrier layer is formed from a plurality of manufactured composite particles that include a plurality of solid pieces having a hydratable material applied thereto. A flexible membrane layer is provided on top of the layer of barrier layer. A method of producing such a landfill is also disclosed.

### CROSS-REFERENCE TO RELATED APPLICATIONS

This application claims the benefit of U.S. Provisional Application No. 61/543,452 filed Oct. 5, 2011, the disclosure of which is incorporated herein by reference.

### BACKGROUND OF THE INVENTION

Landfills are locations where garbage is dumped and buried. A majority of solid waste is buried in municipal solid waste landfills that are lined and covered to prevent the landfilled wastes from harming the environment, primarily from the generation of leachate and methane gases as a result of precipitation and biodegradation, respectively.

Typically, a landfill is capped or covered by constructing a recompacted low-permeability soil layer over the waste material so as to provide a low permeability barrier. The cap can also be composed of a composite design by applying a flexible membrane layer over the recompacted soil cap layer. The flexible membrane layer is usually made from a suitable plastic material, such as polyethylene or polyvinyl chloride.

The plastic of the flexible membrane layer can degrade over time if it is exposed to ultraviolet radiation from the sun. Consequently, a typical landfill that uses a flexible membrane layer also includes a layer of soil that is provided on top thereof to protect the flexible membrane layer from ultraviolet radiation. In addition, the recompacted low permeability soil layer should be protected from desiccation or freezing to prevent the recompacted soil cap barrier from cracking. This is generally accomplished by the use of an additional soil layer or protective vegetative layer. The additional soil layer or protective vegetative layer is usually between six inches and four feet in thickness. Also typically, the additional soil layer or protective vegetative layer may be planted with grass to protect it from erosion. A drainage layer may also be included between the flexible membrane layer and the additional soil layer or protective vegetative layer.

Recently, some landfills have installed solar panels on top of the capped landfill to generate power. Currently, such installations generally are mounted on frames above the surface of the landfill. In another application, flexible solar panels have been glued directly to an ultraviolet-resistant flexible membrane layer. This converts the otherwise vacant landfill into a positive asset by generating solar power.

It would be beneficial to provide new structures for landfills that are effective in capping the landfills and in providing a foundation for solar panels to be installed on top of the capped landfills, in conjunction with other engineered materials that are resistant to the effects of desiccation and freezing, and in such a manner as to provide more ultraviolet protection for the flexible membrane layer.

### SUMMARY OF THE INVENTION

This invention relates to an improved structure for a landfill. The landfill includes a layer of solid waste and a barrier layer provided on top of the layer of solid waste. The barrier layer is formed from a plurality of manufactured composite particles that include a plurality of solid pieces having a hydratable material applied thereto. A flexible membrane layer is provided on top of the layer of barrier layer. A method of producing such a landfill is also disclosed.

### BRIEF DESCRIPTION OF THE DRAWINGS

FIG. 1 is a schematic elevational view of a conventional structure for a landfill.

FIG. 2 is a schematic elevational view of an improved structure for a landfill in accordance with this invention.

### DETAILED DESCRIPTION OF THE PREFERRED EMBODIMENT

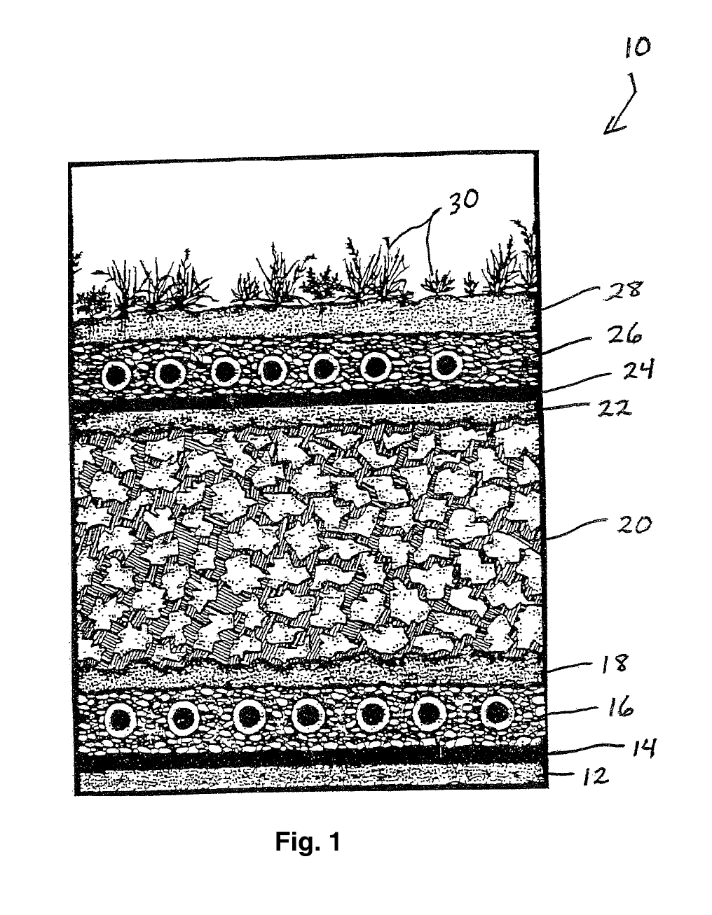

Referring now to the drawings, there is illustrated in FIG. 1 a conventional structure for a landfill, indicated generally at 10. The conventional landfill 10 includes a soil base 12. A layer of a liner 14 is installed on top of the soil base 12. The liner 14 is typically formed from a material that is suitable for protecting the soil base 12 from waste materials in the conventional landfill structure 10. For example, the liner 14 can be made from a suitable plastic material, such as polyethylene or polyvinyl chloride. A leachate (seepage) collection system 16 is installed on top of the liner 14. As is well known, as solid waste degrades over time, it creates a liquid waste material, known as leachate. A soil layer 18 is installed over the leachate collection system 16. A layer of solid waste 20 or other garbage is dumped on top of the soil layer 18. Another soil layer 22 is then applied on top of the solid waste 20.

A flexible membrane layer 24 is installed on top of the soil layer 22. The flexible membrane layer 24 can be formed from the same material as the liner 14. For example, the flexible membrane layer 24 can be made from a suitable plastic material, such as polyethylene or polyvinyl chloride. A drainage layer 26 is installed on top of the flexible membrane layer 24 to prevent moisture from standing on the cap. Finally, a protective soil layer 28 is provided on top of the drainage layer 26. Typically, the protective soil layer 28 is about six inches to about four feet in thickness to not only protect the flexible membrane layer 24 from ultraviolet radiation, but also to protect the soil layer 22 from the effects of desiccation and freezing. Grass 30 or other vegetation may be planted in the protective soil layer 28. In conventional landfills having solar panels (not shown) provided thereon, one or more solar panels (not shown) may be installed on top of the soil layer 28 by means of conventional metal or other rigid frames (not shown) that are supported on the protective soil layer 28.

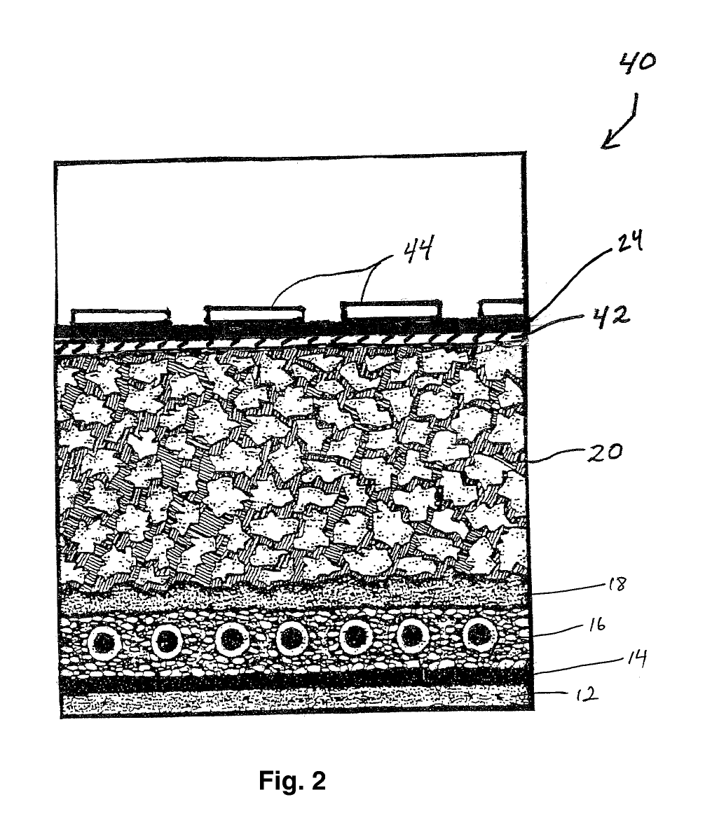

FIG. 2 illustrates an improved structure for a landfill, indicated generally at 40, in accordance with this invention. The structure of the landfill 40 of this invention is, in some respects, similar to the structure of the conventional landfill 10 illustrated in FIG. 1, and like reference numbers are used to indicate similar structures. However, instead of providing (1) the soil layer 22 on top of the solid waste 20, (2) the flexible membrane layer 24 on top of the soil layer 22, (3) the drainage layer 26 on top of the flexible membrane layer 24, and (4) the protective soil layer 28 on top of the drainage layer 26 as described above, the improved landfill 40 of this invention provides merely (1) a barrier layer 42 on top of the solid waste 20 and (2) a flexible membrane layer 24 on top of the barrier layer 42.

The barrier layer 42 may be produced from a plurality of manufactured composite particles. The composite particles of the barrier layer 42 can include solid pieces having a hydratable material applied thereto. The solid pieces of the composite particles can be formed from any suitable material. Some examples of suitable materials include aggregate, such as pieces of rock or stone, iron ore, slag, glass cullet, crushed glass, or crushed porcelain. In some applications, the solid pieces can be relatively dense compared to the hydratable material. The solid pieces can also have any suitable shape, such as angular, sub-angular, sub-rounded, or rounded.

The hydratable material can be any material that is hydratable and suitable for use in the cementitious composition. In certain embodiments, the hydratable material expands upon hydration. For example, in certain embodiments, the hydratable material is a clay mineral or a mixture of clay minerals. Any type of clay mineral can be used, such as bentonite, attapulgite, and/or kaolinite. A clay-sized material can also be used, such as gypsum or other materials, having an average particle size of less than about ten microns. The hydratable material may also include other clay-sized or quasi clay-sized materials, such as organophylic bentonite, zeolites, and inorganic oxides of aluminum, iron, and/or manganese.

Optionally, the hydratable material can also include a binder. The binder may be provided to promote the adhesion of the hydratable material to the solid pieces and/or otherwise help to hold the hydratable material together. Any suitable binder can be used including, for example, a polymeric material such as a cellulosic polymer. Other suitable binders include glues, lignites (sap), starch grafted polyacrylates, and soybean oil lecithins and their derivatives.

Each of the composite particles may be provided with an outer coating, such as a thin polymeric coating that is provided about the solid piece and the hydratable material. Some examples of suitable polymers include acrylic resins and latexes. The outer coating is preferably sufficiently thin so that it does not prevent hydration of the material.

The composite particles may have a variety of general physical configurations. In one preferred embodiment, the composite particles are manufactured composite particles of the type sold as the AquaBlok® composite particle system by AquaBlok, Ltd., Toledo, Ohio. The AquaBlok® composite particle system is described in the following patents, all of which are incorporated by reference herein: U.S. Pat. No. 5,538,787 issued Jul. 23, 1996; U.S. Pat. No. 5,897,946 issued Apr. 27, 1999; U.S. Pat. No. 6,386,796 issued May 14, 2002; and U.S. Pat. No. 6,558,081 issued May 6, 2003. In one embodiment, each composite particle comprises a solid piece including a relatively dense core and having a hydratable material in the form of a layer at least partially encapsulating the core.

The barrier layer 42 can be produced from the manufactured composite particles in any suitable manner. In certain embodiments, the composite particles are applied as a layer on the landfill using any suitable application equipment. Then, the composite particles are hydrated, either by allowing them to be hydrated by rainfall or by applying water or other suitable liquid to the composite particles. The hydration of the particles causes them to form a substantially continuous barrier layer 42. The barrier layer 42 can be any suitable thickness. In certain embodiments, the barrier layer 42 can be between about one inch and about eight inches thick. In other embodiments, the barrier layer 42 can be composed of a manufactured geocomposite/clay layer liner material.

The barrier layer 42 in the landfill 40 of this invention is more effective than the soil layer 28 in the conventional landfill 10 in several aspects. For example, the barrier layer 42 in the landfill 40 of this invention can be substantially thinner than the soil layer 28 in the conventional landfill 10, can be more resistant to desiccation, can reheal itself from freeze-induced cracks when it thaws, and does not require the entire installation to include a protective soil layer.

Also, in certain embodiments, the barrier layer 42 in the landfill 40 of this invention is more effective than the soil layer 28 in the conventional landfill 10 in providing a stable foundation for the installation of the flexible membrane layer 24 and a plurality of solar panels 44 installed on top of the flexible membrane layer 24, as shown in FIG. 2. Such as arrangement provides desirable coverage of the flexible membrane layer 24, which provides ultraviolet protection to the flexible membrane layer 24. Optionally, a layer of soil (not shown) may be provided either above or below the barrier layer 42. This optional soil layer can be substantially thinner than the six inches to four feet thickness typically used in the soil layer 28, as described above.

Because the barrier layer 42 of this invention is hydratable, it will have a very low permeability, thereby repelling water that might otherwise leak through any imperfections in the flexible membrane layer 24. Thus, the barrier layer 42 of this invention is well suited for minimizing leachate produced by the solid waste 20 and, in conjunction with the flexible membrane layer 24, can help contain migration of methane through the cap.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A landfill comprising:
a layer of solid waste;
a barrier layer provided on top of the layer of solid waste, the barrier layer being formed from a plurality of composite particles that include a plurality of solid pieces having a hydratable material applied thereto; and
a flexible membrane layer provided on top of the layer of barrier layer.

2. The landfill defined in claim 1 wherein the solid pieces of the composite particles are formed from aggregate, such as pieces of rock or stone, iron ore, slag, glass cullet, crushed glass, or crushed porcelain.

3. The landfill defined in claim 1 wherein the solid pieces are relatively dense compared to the hydratable material.

4. The landfill defined in claim 1 wherein the hydratable material is a material that is hydratable and suitable for use in the cementitious composition.

5. The landfill defined in claim 1 wherein the hydratable material is a clay mineral or a mixture of clay minerals.

6. The landfill defined in claim 1 wherein the hydratable material includes a binder.

7. The landfill defined in claim 1 wherein each of the composite particles is provided with an outer coating.

8. A method of producing a landfill comprising the steps of:
(a) providing a layer of solid waste;
(b) providing a barrier layer on top of the layer of solid waste, the barrier layer being formed from a plurality of composite particles that include a plurality of solid pieces having a hydratable material applied thereto; and
(c) providing a flexible membrane layer on top of the layer of barrier layer.

9. The method defined in claim 8 wherein step (b) is performed by initially applying the composite particles on top of the layer of solid waste, then subsequently hydrating the composite particles to form the barrier layer.

10. The method defined in claim 8 wherein step (b) is performed by providing a substantially continuous barrier layer on top of the layer of solid waste.
